(19) United States
(12) Patent Application Publication
(10) Pub. No.: US 2011/0260344 A1
(43) Pub. Date: Oct. 27, 2011

(54) Liquid and Gas Mixing Cartridge

(76) Inventors: John W. Shanahan, White Bear Lake, MN (US); John H. Burban, Lake Elmo, MN (US); Kenneth A. Peterson, Temecula, CA (US); Robert O. Crowder, Lino Lakes, MN (US); Xijing Zhang, North Saint Paul, MN (US); Michael Saveliev, Huntington Beach, CA (US); Kevin Carlson, Chino Hills, CA (US)

(21) Appl. No.: 12/765,689

(22) Filed: Apr. 22, 2010

Related U.S. Application Data
(60) Provisional application No. 61/171,764, filed on Apr. 22, 2009.

(51) Int. Cl. B01F 3/04; A23L 2/54

(52) U.S. Cl. 261/152; 261/24; 261/21; 261/58; 261/23.1; 261/100; 261/34.1

(57) ABSTRACT

Embodiments of the invention provide a carbonation system or gas delivery system including a liquid inlet, a gas inlet, a mixture outlet, and a mixing cartridge or membrane module. The mixing cartridge or membrane module can enhance the simultaneous absorption of gas and the transfer of heat out of the liquid.

### RELATED APPLICATIONS

This application claims priority under 35 U.S.C. §119 to U.S. Provisional Patent Application No. 61/171,764 filed on Apr. 22, 2009, the entire contents of which is incorporated herein by reference.

### BACKGROUND

Carbonating a liquid, such as beverages including water, soda, or beer, can involve injecting carbon dioxide gas directly into a supply of the liquid. In this mode of operation, metering the carbon dioxide into the water requires accurate control to prevent over or under carbonation. The production and/or development of large bubbles of carbon dioxide gas in the system can reduce the surface area available for carbon dioxide dissolution. Poor mixing, pressure drop along the liquid path, and warm water temperatures can reduce the rate at which carbon dioxide dissolves in water. If these factors are not considered in the design of a carbonation system, the carbon dioxide can be wasted and the system can be inefficient.

### SUMMARY

Embodiments of the invention provide a carbonation system including a liquid inlet, a gas inlet, a mixture outlet, and a mixing cartridge having a cartridge inlet and a cartridge outlet. The cartridge inlet is in fluid communication with the liquid inlet and the gas inlet. The cartridge outlet is in fluid communication with the mixture outlet. In some embodiments, the mixing cartridge can simultaneously enhance the absorption of a gas coming from the gas inlet into a liquid coming from the liquid inlet and transfer heat out of the gas and the liquid into an external heat sink.

In some embodiments, the system can include a pump upstream of the mixing cartridge that meters a ratio of gas and liquid into a two-phase flow. The pump can simultaneously boost a pressure of the two-phase flow above a pressure at the pump inlet while providing a flow with minimal pulsation.

In some embodiments, the system can include diffuser media upstream of the mixing cartridge and in fluid communication with the liquid inlet and the gas inlet. The diffuser media can include hydrophilic media having a sufficient surface area to deliver small bubbles of gas from a pressurized line to a liquid stream at a predefined volumetric ratio to produce a two-phase flow of liquid and gas.

In some embodiments, the system can include a blending assembly downstream from the mixing cartridge. The blending assembly can include a first pressure-reducing valve and a first flow control in fluid communication with the liquid inlet and a dispense line. The blending assembly can also include a second pressure-reducing valve and a second flow control in fluid communication with the mixture outlet and the dispense line. One or more of the first pressure-reducing valve, the first flow control, the second pressure-reducing valve, and the second flow control can be adjustable to modify a carbonation level in the dispense line. In some embodiments, the system can include two or more blending assemblies to provide different carbonation levels to different dispense lines.

### DESCRIPTION OF THE DRAWINGS

FIG. 1 is a schematic illustration of an inline carbonation system including a mixing cartridge according to one embodiment of the invention.

FIG. 2 is a schematic illustration of an inline carbonation system including a mixing cartridge according to another embodiment of the invention.

FIG. 3 is a schematic illustration of a gas stripping system including the mixing cartridge according to another embodiment of the invention.

FIG. 4 is a schematic illustration of an inline carbonation system including a membrane module according to yet another embodiment of the invention.

FIG. 5 is a cross-sectional view of a membrane for use with the membrane module of FIG. 4 according to one embodiment of the invention.

FIG. 6 is a side view of the membrane module of FIG. 4 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

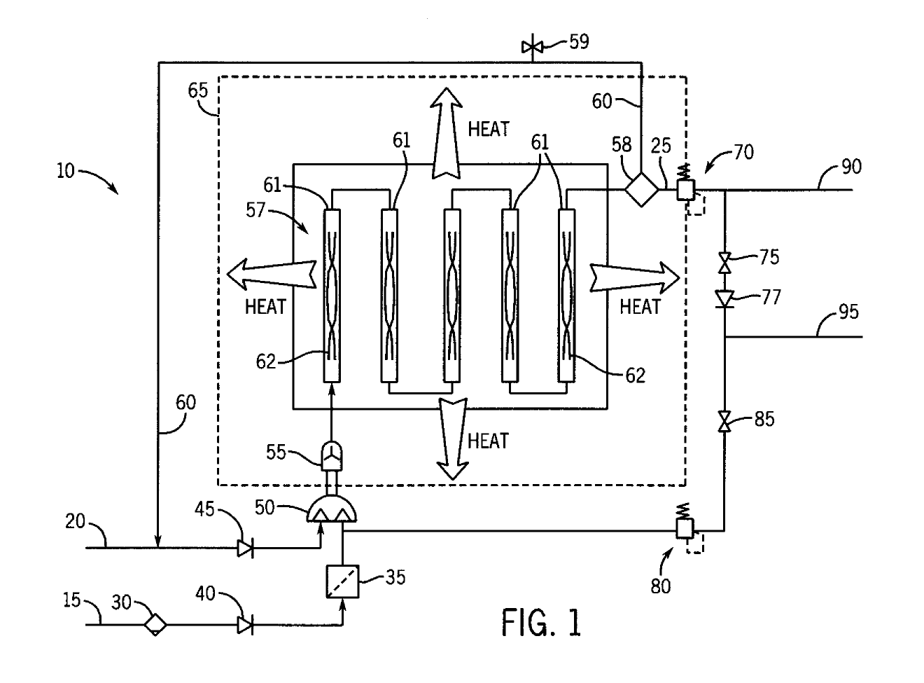

FIG. 1 illustrates an inline carbonation system 10 according to one embodiment of the invention. The inline carbonation system 10 can include a liquid inlet 15, a gas inlet 20, and a carbonated water outlet 25. The inline carbonation system 10 can further include an air vent 30, a filter 35, a liquid check valve 40, a gas check valve 45, a pump 50, diffuser media 55 to produce carbon dioxide bubbles in the liquid stream, a mixing cartridge 57, a post carbonation gas vent 58, a vent release 59 to atmosphere, a gas recycle line 60, and one or more mixing elements 61.

In some embodiments, the pump 50 can be a gas-driven liquid pump. The pump 50 can meter a specific ratio of gas and liquid into a two-phase flow. Simultaneously, the pump 50 can boost the pressure of the two-phase flow above a liquid pressure at the inlet of the pump 50, while providing a flow that is nearly free of pulsation. In some embodiments, the pump 50 can be a rotary positive displacement pump used to achieve a flow with minimal pulsation. A ratio of gas volume to liquid volume in the pump 50 can be minimized in order to achieve the maximum consistent outlet boost. In some embodiments, the outlet gas flow from the pump 50 can be delivered to a diffuser before entering a boosted liquid stream. At least a portion of the gas supplied to the pump 50 can be exhausted to the atmosphere.

Downstream of the mixing cartridge 57, the carbonated fluid mixture can exit the inline carbonation system 10 through the mixture outlet 25 for further processing. The gas vent 58 can be fluidly regulated to the gas inlet 20, the mixing cartridge 57, and the fluid outlet 25. The gas vent 58 can be positioned between the mixing cartridge 57 and the mixture outlet 25. Downstream of the mixing cartridge 57, the carbonated fluid mixture can still include some undissolved gas. The gas vent 58 can help remove the undissolved gas from the carbonated fluid mixture. The undissolved gas that is separated from the carbonated fluid mixture in the gas vent 58 can flow through the gas recycle line 60 or can be vented to atmosphere via a valve 59. The gas recycle line 60 and the gas inlet 20 can be joined so that the recycled gas can be used again and mixed with the liquid in the pump.

In some embodiments, the mixing cartridge 57 and/or the mixing elements 61 can be in direct or indirect contact with a heat sink 65. The external surfaces of the mixing cartridge 57 and/or the mixing elements 61 can be in contact with ice, cold water, or some other type of heat sink, and the mixing cartridge 57 can cool the liquid as the liquid sits stagnant within or flows through the mixing cartridge 57.

In some embodiments, a water pressure regulator 70 and/or a flow control 75 can be in fluid communication with the carbonated water outlet 25. A check valve 77 can be positioned downstream of the flow control 75. Additionally, a water pressure regulator 80 and/or a flow control 85 can be in fluid communication with the liquid inlet 15. The flow through the carbonated water outlet 25 and the flow through the liquid inlet 15 (e.g., tap water) can be joined before a dispense line 90.

Liquid can enter the inline carbonation system 10 through the liquid inlet 15. The liquid can flow through the filter 35, which can remove undissolved solids from the incoming liquid in order to protect the mixing elements 61 from malfunctioning. The filter 35 can include carbon to remove chlorine and other chemicals. The pump 50 and the diffuser media 55, which can boost the liquid pressure and/or mix the liquid with the gas coming from the gas inlet 20, can be positioned downstream of the filter 35.

In some embodiments, the diffuser media 55 can include hydrophilic media. The hydrophilic media can have a sufficient surface area to deliver small bubbles of gas from a pressurized line to a liquid stream at a predefined volumetric ratio to produce a two-phase flow of liquid and gas to the carbonated water outlet 25. In some embodiments, the hydrophilic media can include an underlying layer of media to substantially prevent the migration of liquid to the gas side of the hydrophilic media. In some embodiments, a housing for the diffuser media 55 can be constructed of hydrophilic materials to substantially prevent the development of large bubbles. In some embodiments, a surface of the housing of the diffuser media 55 can be substantially continuous to help prevent the development of large bubbles. After the diffuser media 55, the liquid and the gas can be joined into a single stream, but can remain mostly separate. This liquid and gas mixture can then enter the mixing elements 61.

In one embodiment, the mixing elements 61 can include internal mixing devices 62 to improve the gas absorption into the liquid and heat transfer out of the liquid. These mixing devices 62 can include porous or helical plates, textured walls, and/or non-circular cross sections, which can passively change the fluid flow. The mixing devices can also have other geometries, such as humps, triangles, diamonds, cylinders, etc. The mixing elements 61 can also contain packing material of any suitable geometry. The gas and the liquid can be passed through the mixing cartridge 57 and the gas can be substantially dissolved in the liquid. Although five mixing elements 61 are shown in FIG. 1, other numbers of mixing elements 61 (in series, in parallel, or in a combination of both) can be included in the inline carbonation system 10. The mixing elements 61 can be used in numerous applications other than the above-described carbonation process. The mixing elements 61 can be used for blending fluids, such as two or more gasses, two or more liquids, or gasses and liquids.

Downstream of the mixing elements 61, the carbonated fluid can exit the inline carbonation system 10 and be directed to the dispense line 90. Alternatively, the carbonated liquid can be blended with non-carbonated liquid. The amount of carbonation in this blended liquid can be adjusted with the flow controls 75, 85. This blended water can be directed to a separate dispense line 95. Although only two dispense lines 90, 95 are shown, increased numbers of blended lines can be included to span a wide range of output carbonation levels.

The inline carbonation system 10 can be an on-demand carbonation device by eliminating the need to store the carbonated fluid mixture. For example, the inline carbonation system 10 can be used to carbonate beer on demand, which can eliminate the need to store the beer in high-pressure kegs.

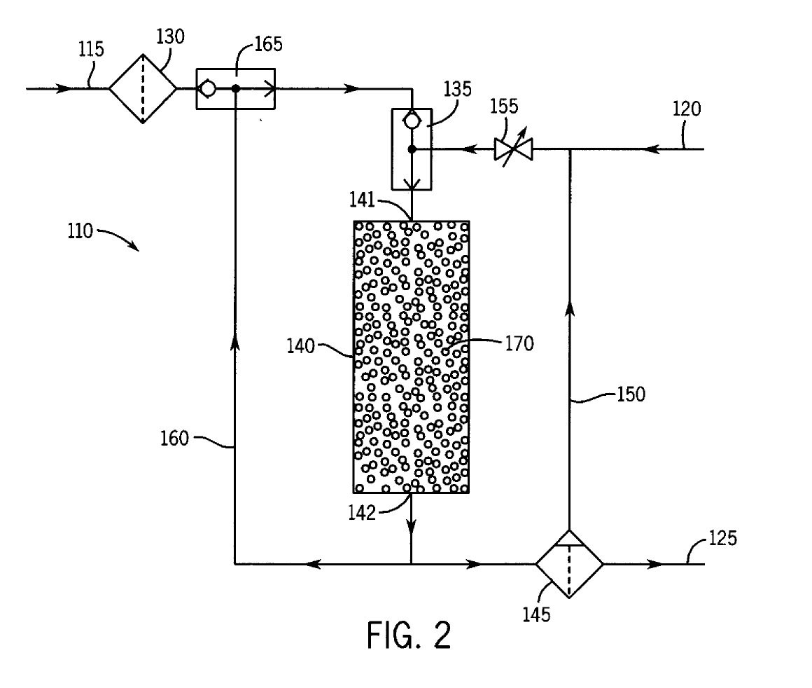

FIG. 2 illustrates an inline carbonation system 110 according to another embodiment of the invention. The inline carbonation system 110 can include a liquid inlet 115, a regulated gas inlet 120, and a mixture outlet 125. The inline carbonation system 110 can further include a filter 130, a blend assembly 135 (that may include a diffuser), a mixing cartridge 140 having an inlet 141 and an outlet 142, a gas vent 145, a gas recycle line 150, a liquid recirculation line 160, and a recirculation valve 165. In some embodiments, the recirculation valve 165 can be a venturi valve.

Liquid can enter the inline carbonation system 110 through the liquid inlet 115. The liquid can flow through the filter 130, which can remove undissolved solids from the incoming liquid in order to protect the mixing cartridge 140 from malfunctioning. The filter 130 can include carbon to remove chlorine and other chemicals. The blend assembly 135, which can mix the liquid with the gas coming from the gas inlet 120 and/or the gas vent 145, can be positioned downstream of the filter 130. After the blend assembly 135, the liquid and the gas can be joined into a single stream, but can remain mostly separate. This liquid and gas mixture can then enter the mixing cartridge 140.

In one embodiment, the mixing cartridge 140 can include a packed bed of beads 170. In one embodiment, the beads 170 can be substantially spherical. In other embodiments, the beads 170 can include any suitable type of granule. The beads 170 can breakdown the gas of the fluid mixture into smaller bubbles. The size of the gas bubbles can decrease from an inlet 141 to an outlet 142 of the mixing cartridge 140. The size of the beads 170 and the density of the packed bed can determine the resulting size of the gas bubbles, which, in turn, can influence the mass transfer of the gas into the liquid. The beads 170 can be designed to achieve a certain bubble size in order to enhance absorption of the gas due to an increased surface area of the gas in contact with the liquid. The beads 170 can be solid or can be coated with a material different from a core material. A coating for the beads 170 can be chosen to enhance the carbonation process inside the mixing cartridge 140. In one embodiment, the beads 170 can induce a reaction to enhance absorption of the gas.

The mixing cartridge 140 can include additional mixing devices to improve the gas absorption into the liquid. These mixing devices can include porous or helical plates, which can passively change the fluid flow. The mixing devices can also have other geometries, such as humps, triangles, diamonds, cylinders, etc.

Downstream of the mixing cartridge 140, the carbonated fluid mixture can exit the inline carbonation system 110 through the mixture outlet 125 for further processing. The gas vent 145 can be fluidly connected to the gas recycle line 150, the mixing cartridge 140, and the fluid outlet 125. The gas vent 145 can be positioned between the mixing cartridge 140 and the mixture outlet 125. Downstream of the mixing cartridge 140, the carbonated fluid mixture can still include some undissolved gas. The gas vent 145 can help remove the undissolved gas from the carbonated fluid mixture. The undissolved gas that is separated from the carbonated fluid mixture in the gas vent 145 can flow through the gas recycle line 150. The gas recycle line 150 and the gas inlet 120 can be joined by the valve 155 so that the recycled gas can be mixed with the liquid in the blend assembly 135.

Recycling the undissolved gas from the carbonated fluid mixture can reduce the flow rate of “fresh” gas through the gas inlet 120 and can help increase the overall efficiency of the inline carbonation system 110. The inline carbonation system 110 can be an on-demand carbonation device by eliminating the need to store the carbonated fluid mixture. For example, the inline carbonation system 110 can be used to carbonize beer on demand, which can eliminate the need to store the beer in high-pressure kegs.

The size of the beads 170, the velocity of the fluid mixture inside the mixing cartridge 140, the size of the mixing cartridge 140 (particularly the distance between the inlet 141 and the outlet 142), and the time the fluid mixture is inside the mixing cartridge 140 can determine the level of carbonation. For higher carbonation rates, a portion of the carbonated fluid mixture can enter the liquid recirculation line 160 downstream of the mixing cartridge 140. Upstream of the mixing cartridge 140, the recirculation valve 165 can mix the carbonated fluid mixture coming from the liquid recirculation line 160 with the “fresh” liquid coming from the liquid inlet 115. Depending on the desired carbonation level, the flow rate of the “fresh” liquid coming from the liquid inlet 115 can be substantially zero in order to pass all of the carbonated fluid mixture back through the packed bed of beads 170.

In some embodiments, the inline carbonation systems 10, 110 can provide one or more of the following attributes or advantages. The inline carbonation system 10, 110 can provide little or no gas head space so that the system does not trap undesirable gasses, such as oxygen and nitrogen. The inline operation can provide consistent performance through high demand periods. The inline carbonation systems 10, 110 can eliminate liquid level controls. The inline carbonation systems 10, 110 can help to improve energy efficiency by eliminating the need for a pump deck (e.g., pump motor eliminated and no dedicated circuit required). The inline carbonation systems 10, 110 can allow plumbing systems to provide variable carbonation levels, if desired. The inline carbonation systems 10, 110 provide a minimal hold-up volume that helps ensure fresh carbonated water is supplied at every dispense and that substantially reduces the amount of water that may be over-carbonated during stagnant periods. The inline carbonation systems 10, 110 can provide defined interfacial area for high rates of mass transfer and consistent carbonation levels. The inline carbonation systems 10, 110 can have a polymeric construction that reduces weight and alleviates corrosion concerns. The inline carbonation systems 10, 110 can eliminate the need for a gas outlet. The inline carbonation systems 10, 110 can include quick connect features. The inline carbonation systems 10, 110 can be scalable for different applications. The inline carbonation systems 10, 110 can have a modular design for use with water boost systems. The inline carbonation systems 10, 110 can operate at a medium pressure (e.g., 100 pounds per square inch gauge).

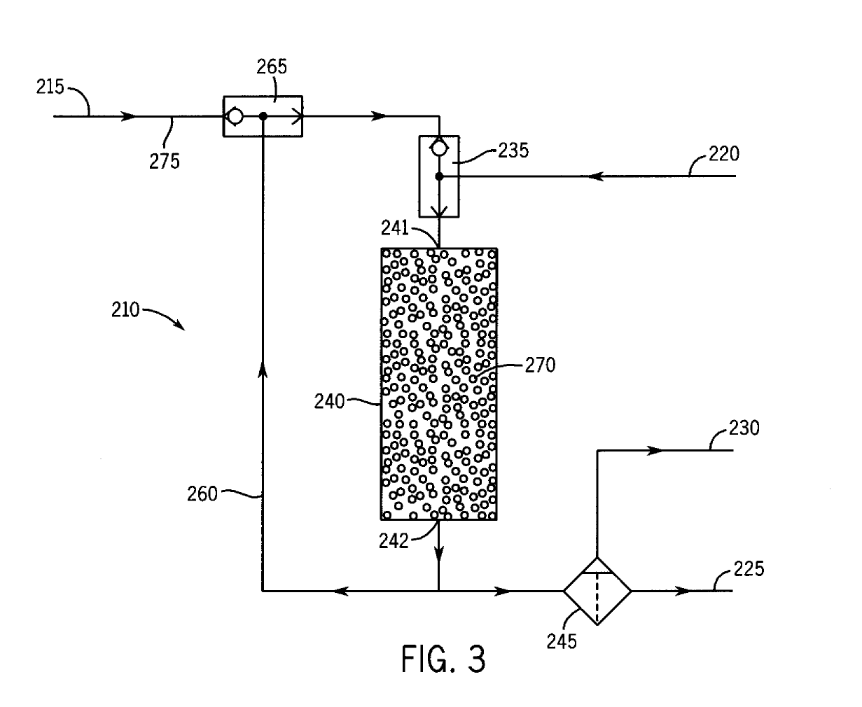

FIG. 3 illustrates a gas stripping system 210 according to another embodiment of the invention. The gas stripping system 210 can include a mixture inlet 215, a stripping gas inlet 220, a liquid outlet 225, and a gas outlet 230. The gas stripping system 210 can further include a blend assembly 235, a mixing cartridge 240 having an inlet 241 and an outlet 242, a gas vent 245 (e.g., a membrane), a liquid recirculation line 260, and a recirculation valve 265. A mixture of liquid and gas can enter the gas stripping system 210 through the mixture inlet 215. The liquid-gas mixture can pass through the recirculation valve 265.

A stripping gas can be added through the stripping gas inlet 220. The stripping gas and the liquid-gas mixture can be mixed by the blend assembly 235 before the combined mixture can enter the mixing cartridge 240 through the inlet 241. The mixing cartridge 240 can include a packed bed of beads 270. The size, outer material, and packing density of the beads 270 can contribute to the mixing of the stripping gas with the liquid-gas mixture.

The combination of the liquid-gas mixture and the stripping gas can exit the mixing cartridge 240 through the outlet 242 before entering the gas vent 245. An inlet of the gas vent 245 can be fluidly connected to the outlet 242 of the mixing cartridge 240, while a first outlet of the gas vent 245 can be fluidly connected to the liquid outlet 225 and a second outlet of the gas vent 245 can be connected to the gas outlet 230. The gas vent 245 can separate the combined stripping gas and the gas of the mixture from the liquid of the mixture, so that the combined gas can exit the gas stripping system 210 through the gas outlet 230 and the liquid of the mixture can exit through the liquid outlet 225. The gas exiting the gas outlet 230 can be further processed so that the stripping gas can be recycled into the gas stripping inlet 220.

The velocity of the liquid-gas mixture inside the mixing cartridge 240, the size of the mixing cartridge 240 (particularly the distance between the inlet 241 and the outlet 242), and the time the mixture and the stripping gas remain in the mixing cartridge 240 can determine the level of absorption of the stripping gas into the mixture. A portion of the combination of the mixture and the stripping gas can enter the liquid recirculation line 260 downstream of the mixing cartridge 240 and upstream of the gas vent 245. The recirculation valve 265 can join the combination of the mixture and the stripping gas coming from the recirculation line 260 and the mixture coming from the mixture inlet 215 upstream of the mixing cartridge 240. Depending on the desired stripping, the flow rate of the mixture coming from the mixture inlet 215 can be substantially zero in order to pass all of the old mixture back through the backed bed of beads 270 with new stripping gas.

The gas stripping system 210 can be used, for example, in water treatment systems to extract chloramine. In typical water treatment systems, carbon is used to remove chlorine from the water supply at the point of use; however, carbon is not as effective for chloramine removal and larger quantities of carbon must be used. In other words, to extract chloramine, a higher amount of carbon is necessary than for extracting chlorine. In some embodiments of the invention, the gas stripping system 210 can eliminate or at least reduce the need for carbon to extract chloramine. The mixing cartridge 240 can be used to blend a stripping gas and a chemical feed 275 into the water treated with chloramine. Downstream of the mixing cartridge 240, the stripping gas and the chloramine can be collected by the gas vent 245 so that the drinking water can exit the liquid outlet 225.

The various embodiments of the mixing cartridges 57, 140, 240 can be used in numerous applications other than the above-described carbonation and gas stripping processes. The mixing cartridges 57, 140, 240 can be used for blending fluids, such as two or more gasses, two or more liquids, or liquids and gasses.

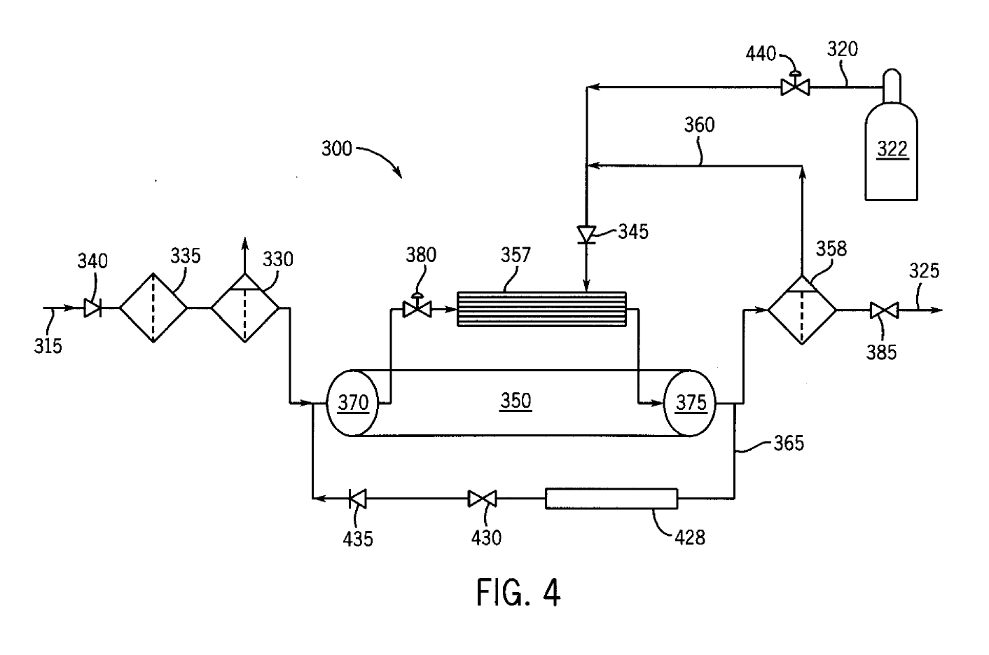

FIG. 4 illustrates an inline carbonation system 300 according to an alternative embodiment of the invention. Similar to the embodiments shown and described with respect to FIGS. 1 and 2, the inline carbonation system 300 can include a liquid inlet 315, a gas inlet 320, and a carbonated water outlet 325. The gas inlet 320 can be coupled to a gas cylinder 322 (e.g., a carbon dioxide gas cylinder). The inline carbonation system 300 can further include an air vent 330, a filter 335, a liquid check valve 340, a gas check valve 345, a pump 350, a gas delivery module 357, a post carbonation vent 358, a gas recycle line 360, and a liquid recirculation line 365.

The liquid can enter the inline carbonation system 300 through the liquid inlet 315, and pass through the liquid check valve 340 and the filter 335. The filter 335 is an optional component of the system 300 and can be an activated carbon filter to remove chlorine and other chemicals, in some embodiments. The filter 335 can remove undissolved solids from the incoming liquid. The liquid can flow through the air vent 330 in order to release some gas to atmosphere. The liquid can then flow to the pump 350. The pump 350 can be positioned downstream of the filter 335 and can boost the liquid pressure before the gas delivery module 357.

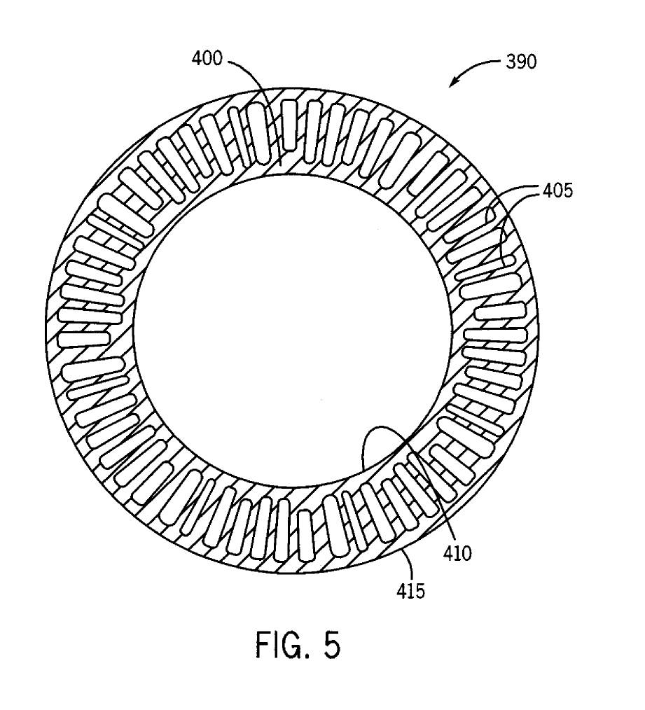

In some embodiments, the pump 350 can be a dual-headed pump that uses a single motor with two output shafts, as disclosed in co-pending United States Patent Application Publication No. 2009/0194478, the entire contents of which is herein incorporated by reference. The pump 350 can include a first head 370 and a second head 375. The first head 370 can boost the pressure of the liquid before entering the gas delivery module 357. Despite the liquid pressure being boosted by the first head 370 of the pump 350, the system 300 can provide gas to the gas delivery module 357 at a higher pressure than the pressure of the liquid entering the gas delivery module 357. This differential pressure may result in gas being bubbled through a membrane 390 (as shown in FIG. 5) or media over some or all of the membrane 390 or media surface into the outgoing liquid. The bubbles are promoted by advection (i.e., forced convection) of gas through the membrane 390 or media pores, which may occur in addition to the gas being transferred to the outgoing liquid by diffusive mass transfer. The advective flow of gas per surface area per time may be higher than the diffusive flow. As a result, this combined advective and diffusive method delivers substantially more gas to the outgoing liquid than if the incoming liquid pressure were higher than the incoming gas pressure into the gas delivery module 357. The system 300 can also include a pressure regulator 380 downstream of the first head 370 and upstream of the gas delivery module 357.

FIG. 5 illustrates one embodiment of the membrane 390 for use in the gas delivery module 357. The membrane 390 can include a porous membrane support 400 and macrovoids or larger pores 405. In some embodiments, the membrane 390 can have a circular cross-sectional structure including the porous membrane support 400 and/or the macrovoids 405. The membrane 390 can have a liquid/mixed fluid (internal) side 410 and a gas (housing or external) side 415. The membrane 390 can be contacted by two separate streams. For example, a first stream of liquid can flow along the side 410 and a second stream of gas can flow along the side 415.

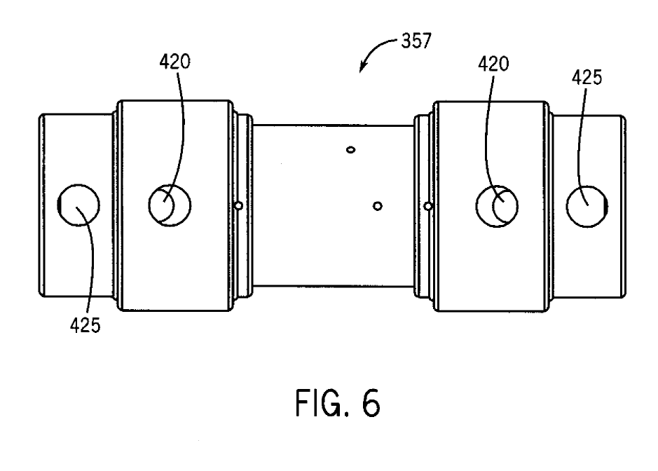

FIG. 6 illustrates one example of a housing of the gas delivery module 357. The gas delivery module 357 can be a stand-alone module that performs both the metering of gas and the mixing of gas and liquid at the same time. The gas delivery module 357 can include one or more gas side ports 420 and liquid/mixed fluid side ports 425. In one embodiment, the first stream can enter and exit the liquid/mixed fluid side ports 425 and the second stream can enter the gas side ports 420. Within the gas delivery module 357, the first stream and the second stream can be separated by the membrane 390 and/or media. In one embodiment, the pressurized gas can be delivered to the gas side ports 420. The liquid can be delivered to one liquid/mixed fluid side port 425 and exit through the other liquid/mixed fluid side port 425. However, in other embodiments, this arrangement can be reversed so that pressurized gas is delivered to the side 410 and liquid is delivered to the side 415 of the membrane 390 and/or media.

The gas delivery module 357 can be designed to optimize mass transfer across the membrane 390, heat transfer across membrane 390, and energy losses in the fluid streams supplied to the gas delivery module 357. In some embodiments, the gas delivery module 357 can include one or more flat sheet, hollow fiber, or tubular membranes 390 The membrane or membranes 390 can be placed within the gas delivery module 357 to encourage counter-current flow, co-current flow, cross-flow, or some combination of the above. In some embodiments, media (not shown) can be placed between ports 420 and/or 425 and the gas delivery media or membrane 390 to protect the gas delivery media or membrane 390 from particulates, chemicals, and/or inertia of the incoming or outgoing streams. The protective media can intercept particles, sorb chemicals, and/or reduce the local velocity of the incoming fluid stream. Interception of particles can reduce mechanical failures associated with impaction on and/or abrasion of the membrane surfaces. Sorption of chemicals can reduce the potential for chemical attack and/or fouling of the membranes 390. Reduced fluid velocity on the side 415 can reduce the vibration of the membranes 390 and/or shear forces on the membranes 390, thus reducing the possibility of mechanical failure of the membranes 390. The media can also be included to increase the functionality of the gas delivery module 357. The media can be foam, felt, activated carbon, zeolites, ion exchange resins, silica beads, and/or other suitable materials. The surrounding environment and/or the temperature of the gas delivery module 357 can also be controlled to optimize the performance of mass and/or heat transfer across the membrane 390.

In some embodiments, the chemistry of the membrane of the gas delivery module 357 can be adjusted to alter the size of the gas bubbles (e.g., in order to maximize the surface area of the bubbles). In some embodiments, the membrane can include hydrophilic media. The hydrophilic media can have a sufficient surface area to deliver small bubbles of gas from a pressurized line to a liquid stream at a predefined volumetric ratio to produce a two-phase flow of liquid and gas to the carbonated water outlet 325. In some embodiments, the hydrophilic media can include an underlying layer of media to substantially prevent the migration of liquid to the gas side of the hydrophilic media. In some embodiments, a housing for the gas delivery module 357 can be constructed of hydrophilic materials to substantially prevent the development of large bubbles. In some embodiments, a surface of the housing of the membrane can be substantially continuous to help prevent the development of large bubbles.

As shown in FIG. 5, the second head 375 of the pump 350 can repressurize the two-phase flow exiting the gas delivery module 357. At this point, not all of the gas will be dissolved in the liquid. Repressurizing the flow can help shrink the bubbles and vent the smaller bubbles through the gas vent 358 to be recycled within the system 300. In other words, the pressure of the two-phase flow exiting the gas delivery module 357 can be boosted to a pressure higher than the incoming liquid into the gas delivery module 357 in order to compress the excess gas bubbles that remain undissolved in the two-phase flow.

Downstream of the gas delivery module 357, the carbonated fluid mixture can exit the inline carbonation system 300 through the mixture outlet 325 for further processing. The gas vent 358 can be fluidly regulated to the gas line 320, the gas delivery module 357, and the fluid outlet 325. The gas vent 358 can be positioned between the gas delivery module 357 and the mixture outlet 325. Downstream of the gas delivery module 357, the carbonated fluid mixture can still include some undissolved gas. The gas vent 358 can help remove the undissolved gas from the carbonated fluid mixture. The undissolved gas that is separated from the carbonated fluid mixture in the gas vent 358 can flow through the gas recycle line 360. The gas recycle line 360 and the gas inlet 320 can be joined so that the recycled gas can be mixed with the liquid in the gas delivery module 357.

In some embodiments, a flow control 385 can be in fluid communication with the carbonated water outlet 325. In some embodiments, the system 300 can include a mixing element 428, a flow control 430, and a check valve and/or flow meter 435 to regulate and monitor flow through the liquid recirculation line 365. The mixing element 428 can enhance gas dissolution in the recirculation line 365. The system 300 can further include a gas regulator 440 coupled to the gas inlet 320 and the gas cylinder 322.

The inline carbonation system 300 can be an on-demand carbonation device by eliminating the need to store the carbonated fluid mixture. For example, the inline carbonation system 300 can be used to carbonate water from point-of-use water coolers on demand, which can eliminate the need to store carbonated water separately from the water cooler. The inline carbonation system 300 can be used in smaller, more compact systems having lower flow rates than the systems shown and described with respect to FIGS. 1 and 2.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A carbonation system comprising:
a liquid inlet;
a gas inlet;
a mixture outlet; and
a mixing cartridge having a cartridge inlet and a cartridge outlet, the cartridge inlet in fluid communication with the liquid inlet and the gas inlet, the cartridge outlet in fluid communication with the mixture outlet, the mixing cartridge simultaneously enhancing the absorption of a gas coming from the gas inlet into a liquid coming from the liquid inlet and transferring heat out of the gas and the liquid into an external heat sink.

2. The system of claim 1, wherein the mixing cartridge includes a static mixer.

3. The system of claim 2, wherein a geometry of the static mixer is optimized for simultaneous heat and mass transfer.

4. The system of claim 1, wherein the mixing cartridge is constructed of materials that provide an optimal tradeoff between thermal conductivity and corrosion resistance.

5. The system of claim 1, wherein the mixing cartridge includes a packed bed of the beads.

6. The system of claim 5, wherein the size of the beads is selected to support a mass transfer of the gas into the liquid.

7. The system of claim 5, wherein an outer material of the beads is selected to support a mass transfer of the gas into the liquid.

8. A carbonation system comprising:
a pump including an inlet and an outlet,
the pump metering a ratio of gas and liquid into a two-phase flow,
the pump simultaneously boosting a pressure of the two-phase flow above a pressure at the inlet while providing a flow with minimal pulsation; and
a mixing cartridge in fluid communication with the outlet of the pump, the mixing cartridge enhancing the absorption of the gas into the liquid.

9. The system of claim 8, wherein the pump is a gas-driven rotary positive displacement pump.

10. The system of claim 8, wherein the ratio of gas to liquid is minimized to achieve a maximum consistent outlet boost.

11. The system of claim 8, wherein an outlet gas flow from the pump is delivered to a diffuser before entering a boosted liquid stream.

12. The system of claim 8, wherein a portion of the gas supplied to the pump is exhausted to atmosphere.

13. The system of claim 8, wherein a gas vent is used to capture undissolved gas exiting the mixing cartridge for recycle to at least one of the system inlet and venting to atmosphere.

14. A carbonation system comprising:
a liquid inlet;
a gas inlet;
diffuser media in fluid communication with the liquid inlet and the gas inlet, the diffuser media including hydrophilic media, the hydrophilic media having a sufficient surface area to deliver small bubbles of gas from a pressurized line to a liquid stream at a predefined volumetric ratio to produce a two-phase flow of liquid and gas; and
a mixing cartridge in fluid communication with the diffuser media.

15. The system of claim 14, wherein the hydrophilic media includes an underlying layer of media to substantially prevent the migration of liquid to the gas side of the hydrophilic media.

16. The system of claim 14, wherein a housing for the diffuser media is constructed of materials to substantially prevent the development of large bubbles.

17. The system of claim 16, wherein a surface of the housing is substantially continuous to substantially prevent the development of large bubbles.

18. A carbonation system comprising:
a liquid inlet;
a gas inlet;
a mixture outlet; and
a mixing cartridge having a cartridge inlet and a cartridge outlet, the cartridge inlet in fluid communication with the liquid inlet and the gas inlet, the cartridge outlet in fluid communication with the mixture outlet; and
a blending assembly including
a first pressure-reducing valve and a first flow control in fluid communication with the liquid inlet and a dispense line; and
a second pressure-reducing valve and a second flow control in fluid communication with the mixture outlet and the dispense line;
at least one of the first pressure-reducing valve, the first flow control, the second pressure-reducing valve, and the second flow control being adjustable to modify a carbonation level in the dispense line.

19. The system of claim 18, wherein the blending assembly is operated automatically.

20. The system of claim 18, and further comprising a second blending assembly and a second dispense line capable of delivering a different carbonation level.

21. A carbonation system comprising:
a liquid inlet;
a gas inlet;
a mixture outlet; and
a gas delivery module having at least one of a membrane and media, a module inlet, and a module outlet,
gas from the gas inlet being provided to a first side of the at least one of a membrane and media,
liquid from the liquid inlet being provided to a second side of the at least one of a membrane and media through the module inlet,
gas being transferred through the at least one of a membrane and media to the liquid and absorbed in the liquid by advection and diffusion,
the module outlet in fluid communication with the mixture outlet.

22. The system of claim 21 and further comprising a dual-headed pump including a single motor, a first head, and a second head, the first head boosting pressure at the module inlet, the second head boosting pressure at the module outlet.

22. The system of claim 21 wherein gas is provided to the gas delivery module at a higher pressure than liquid provided to the gas delivery module at the module inlet.

23. The system of claim 22 and further comprising a gas vent positioned downstream of the module outlet and the second head and upstream of the mixture outlet.

24. The system of claim 23 and further comprising a gas recycle line coupled between the gas vent and the gas inlet.

25. The system of claim 21 and further comprising a liquid recirculation line including a mixing element coupled between the module outlet and the module inlet.

26. The system of claim 21 wherein the at least one of a membrane and media includes a hollow fiber porous membrane having a substantially circular cross section with macrovoids.

27. A gas stripping system comprising:
a mixture inlet providing a liquid-gas mixture;
a stripping gas inlet providing a stripping gas;
a blend assembly coupled to the mixture inlet and the stripping gas inlet;
a mixing cartridge coupled to the blend assembly, the mixing cartridge causing gas from the liquid-gas mixture to combine with the stripping gas to formed a combined gas;
a gas vent to remove the combined gas through a gas outlet; and
a liquid outlet to provide purified liquid from the liquid-gas mixture.

28. The system of claim 27 wherein chloramine is extracted from the liquid-gas mixture.

29. The system of claim 27 and further comprising a liquid recirculation line and recirculation valve coupled to the blending assembly.

30. The system of claim 27 wherein the mixing cartridge includes a packed bed of the beads.

31. The system of claim 30, wherein the size of the beads is selected to support mass transfer of the stripping gas into the liquid-gas mixture.
